(19) United States
(12) Patent Application Publication
(10) Pub. No.: US 2012/0171405 A1
(43) Pub. Date: Jul. 5, 2012

(54) Heat-Sealable Polyolefin Films

(75) Inventors: Stefano Pasquali, Ferrara (IT); Gianluca Musacchi, Ferrara (IT); Enrico Beccarini, Ferrara (IT); Inge Elisabeth Roucourt, Huldenberg (BE)

(73) Assignee: BASELL POLIOLEFINE ITALIA S.R.L., Milano (IT)

(21) Appl. No.: 13/496,461

(22) PCT Filed: Sep. 15, 2010
(86) PCT No.: PCT/EP2010/063520

§ 371 Date: Mar. 15, 2012

Related U.S. Application Data
(60) Provisional application No. 61/277,730, filed on Sep. 29, 2009.

(30) Foreign Application Priority Data
Sep. 24, 2009 (EP) 09171170.5

(51) Int. Cl. B32B 1/08; C08L 23/20

(52) U.S. Cl. 428/36.9; 525/240

(57) ABSTRACT

Film or sheet comprising at least one layer of a polyolefin composition consisting, in percentage by weight referred to the sum of component (a1) and (a2) and (b), of:
a1) 42-88 wt % of a propylene homopolymer or copolymer of propylene with ethylene and/or one or more C₄-C₁₀ α-olefin(s), the said homopolymer or copolymer having a solubility in xylene at room temperature (XSm) equal to or less than 10 wt %;
a2) 7-39 wt % of a copolymer of ethylene with propylene and/or one or more C₄-C₁₀ α-olefin(s) containing 50-80 wt % of ethylene derived units and having a solubility in xylene at room temperature of 50-80 wt %; and
(b) 0.5-30 wt %, of a butene-1 (co)polymer having:
   a content of butene-1 derived units of 75 wt % or more,
   a flexural modulus (MEF) of 70 MPa or less.

This application is the U.S. national phase of International Application PCT/EP2010/063520, filed Sep. 15, 2010, claiming priority to European Application 09171170.5 filed Sep. 24, 2009, and the benefit under 35 U.S.C. 119(e) of U.S. Provisional Application No. 61/277,730, filed Sep. 29, 2009; the disclosures of International Application PCT/EP2010/063520, European Application 09171170.5 and U.S. Provisional Application No. 61/277,730, each as filed, are incorporated herein by reference.

The present invention relates to heat-sealable polyolefin films.

Such kind of polyolefin films is widely used in the packaging field, especially in the food packaging field, but also for the packaging non food products and for the production of non-packaging items.

Packaging examples are the primary packaging of hygienic items, textile articles, magazines, mailing films, secondary collation packaging, shrink packaging films and sleeves, stretch packaging films and sleeves, form-fill-seal packaging films for portionating various types of articles such as bags, pouches or sachets, vacuum formed blisters.

Examples of form-fill-seal applications are the packaging of peat and turf, chemicals, plastic resins, mineral products, food products, small size solid articles.

The above applications and, in general, all the applications involving use of plastic films for packaging are included in the general definition of “flexible plastic packaging”.

Non packaging items are for example synthetic clothing articles or medical and surgical films, films which are formed into flexible conveying pipes, membranes for isolation and protection in soil, building and construction applications, films which are laminated with non-woven membranes.

The film is characterized by the presence of at least one polyolefin layer that can be easily sealed to itself or to other materials by applying heat and pressure (heat-sealable layer).

The features of the seal, in particular the seal strength, are determined by the choice and the relative amounts of the olefin polymers composing the sealing layer.

In particular, in EP0556815, EP0560326, EP0674991, WO00/11076 and WO03/031514 various technical solutions are described, based on use of random copolymers of propylene.

On the other hand, polymer products made up of heterophasic mixtures of propylene crystalline polymers and elastomeric olefin copolymers, typically obtained by sequential stereospecific polymerization, are establishing themselves in the polypropylene industry. These products possess a satisfying compromise of elastic properties and mechanical resistance and can easily be transformed into manufactured articles by using the equipments and processes normally used for thermoplastic materials. As disclosed in particular in EP0477662, such polymer products can be used to produce films with improved elongation at break and Elmendorf tear properties and good optical properties.

However, the heat sealing properties of these products are not satisfactory, because in the typical range of sealing temperatures used in the industrial practice, namely from about 95° C. to about 110° C., the seal strength is not particularly high, and also because the heterophasic compositions result to be too sticky for use in packaging films to be heat sealed. (i.e. in the heat sealing layer). Thus, in the international application WO2007047134 an heat-sealable polyolefin film made of specific kinds of heterophasic compositions comprising a relatively high amounts of fillers, the said stickiness problems do not occur, and the seal strength so achieved is high enough for industrial use.

In the international patent application WO2008061843 an heterophasic composition comprising a crystalline propylene homo or copolymer (matrix), and a copolymer of ethylene with C₄-C₁₀ α-olefins (in the examples an ethylene/butene-1 rubber) having low values of MFR that are suitable for film applications, particularly for cast and bioriented films, exhibiting high gas permeability (breath-ability).

It is also known in the art that deterioration of the heat-seal properties is observed after retorting.

It is still felt the need of polyolefin compositions suitable for film layers having good heat seal-ability (seal strength) thus suitable for use as heat sealing layers and particularly suitable also for heat seal application after retort combining sufficient heat seal-ability and a valuable balance of physical-mechanical properties.

It has now surprisingly been found that specific kinds of heterophasic compositions (impact polymers) in blend with certain amounts of at least one butene-1 (co)polymer (plastomer), provide polyolefin compositions exhibiting improved seal strength high enough for industrial use and the above said advantageous balance of properties. Particularly the composition according to the invention exhibit improved heat seal-ability (seal strength) already at a low amount of butene-1 polymer added (lower than 10 wt %) and maintained also after retort, moreover in some case also the seal initiation temperature is lowered. Heat seal-ability is combined with a valuable balance of mechanical properties that are substantially maintained or even in some case improved in comparison to the base heterophasic composition of reference. The mechanical properties are maintained even up to 20 wt % of plastomer addition. Mechanical resistance (Elmendorf) is improved, tensile properties (elongation and stress) are generally maintained and in some case also improved optical properties are observed.

Thus, the said polyolefin compositions are suitable to be used as sealing layer (outermost layer) in a heat-sealing film. Good seal properties are maintained also after retorting.

Therefore, an object of the present invention is a film or sheet comprising at least one layer of a polyolefin composition (I) comprising, in percent by weight referred to the sum of component (a1), (a2) and (b):
a1) 42-88 wt % of a propylene homopolymer or copolymer of propylene with ethylene and/or one or more C₄-C₁₀ α-olefin(s), the said homopolymer or copolymer having a solubility in xylene at room temperature equal to or less than 10 wt %, preferably equal to or less than 5 wt %;
a2) 7-39 wt % of a copolymer of ethylene with propylene and/or one or more C₄-C₁₀ α-olefin(s) containing 50-80 wt % of ethylene derived units and having a solubility in xylene at room temperature of 50-80 wt %; and
(b) 0.5-30 wt %, of a butene-1 (co)polymer having:
   a content of butene-1 derived units of 75 wt % or more, preferably of 80 wt % or more, more preferably of 84 wt % or more, even more preferably of 90 wt % or more,
   a flexural modulus (MEF) of 70 MPa or less, preferably of 60 MPa or less, more preferably of 40 MPa or less, even more preferably of 30 MPa or less.

The term “copolymer” as used herein refers to both polymers with two different recurring units and polymers with more than two different recurring units in the chain, such as terpolymers.

The term “butene-1 (co)polymer” as used herein refers to butene-1 homopolymers, copolymers and compositions thereof, having from elastomeric to plastomeric behaviour and generically also referred to as “plastomers”. The “butene-1 (co)polymer” component (b) exhibit low flexural modulus and more preferably also low crystallinity (less than 40% measured via X-ray, preferably less than 30%). The plastomer is present in the composition from 0.5 to 30 wt %, from 2 to 25 wt %, more preferably 10 wt % or less with respect to the weight of the composition (I).

The composition (I) according to the invention preferably has a value of melt flow rate “L” of from 0.1 to 50g/10 min, preferably of less than 20 g/10 min, even more preferably of less than 10 g/10 min. Preferably, the composition of the present invention exhibits seal initiation temperature of from 125 to 140. Seal initiation temperature is herewith defined as the temperature at 50% of the maximum force plateau in the sealing strength curve obtained as described in the experimental part hereinbelow (substantially corresponding to the temperature at which a seal strength of at least 2N is measured).

Components (a1) (a2) and (b) can be mechanically blended together. Preferred are the polyolefin compositions wherein component (a1) and (a2) are obtained by sequential polymerization (reactor blend) and then blended with component (b). Thus a preferred embodiment is a film or sheet comprising at least one layer of a polyolefin composition (I) comprising, in percent by weight referred to the sum of component (a) and (b):
(a) from about 70 to 98 wt %, preferably from 80 to 98 wt %, more preferably 90 wt % or more of a heterophasic propylene polymer composition obtained by sequential polymerization, comprising, in percentage by weight referred to the sum of component (a1) and (a2):
   (a1) 60-90 wt %, preferably 75-85 wt % of a propylene homopolymer or copolymer of propylene with ethylene and/or one or more C₄-C₁₀ α-olefin(s), the said homopolymer or copolymer having a solubility in xylene at room temperature (XSm) equal to or less than 10 wt %, preferably equal to or less than 5 wt %;
   (a2) 10-40 wt %, preferably 15-25 wt % of a copolymer of ethylene with propylene and/or one or more C₄-C₁₀ α-olefin(s) containing 50-80 wt %, preferably from 70 to 80 wt % of ethylene derived units and having a solubility in xylene at room temperature (XSrub) of 50-80 wt % of component (a2); and
(b) 0.5-30 wt %, preferably from 2 to 25 wt %, more preferably 10 wt % or less of a butene-1 (co)polymer having:
   a content of butene-1 derived units of 75wt % or more, preferably of 80 wt % or more, more preferably of 84 wt % or more, even more preferably of 90 wt % or more
   a flexural modulus (MEF) of 70 MPa or less, preferably of 60 MPa or less, more preferably 40 MPa or less, even more preferably 30 MPa or less.

More preferably the heterophasic composition (a1)+(a2), is a polyolefin composition having a value of melt flow rate (MFR) at 230° C., 2.16 kg of from 0.5 to 10 g/10 min, preferably of from 2 to 8 g/10 min. Particularly preferred features for the compositions (a1+a2) are:
a melting temperature (Tm-DSC) of component (a1) equal to or higher than 150° C. preferably higher than 154° C.
the total content of ethylene of from 5 to 20, preferably from 10 to 18 wt %,
the total content of C₄-C₁₀ α-olefin(s), when present, of from 2 to 8 wt %, preferably from 3 to 7 wt %,
the value of the intrinsic viscosity of the total fraction soluble in xylene at room temperature (XSIVtot) is equal to or less than 3, preferably less than 2, more preferably less than 1.7 dl/g;
the fraction soluble in xylene at room temperature of component (a1) (XSm) equal to or less than 3 wt % , preferably less than 2 wt % .
the melt flow rate MFR (at 230° C., 2.16 Kg) of the matrix component (1) is from 2 to 10 g/10min.
the total fraction soluble in xylene at room temperature (XStot) of less than 20 wt %, preferably of from 10 to 18 wt %

The said C₄-C₁₀ α-olefins, which are or may be present as comonomers in the composition (a1)+(a2), are represented by the formula CH₂═CHR, wherein R is an alkyl radical, linear or branched, with 2-8 carbon atoms or an aryl (in particular phenyl) radical. Examples of said C₄-C₁₀ α-olefins are 1-butene, 1-pentene, 1-hexene, 4-methyl-1-pentene and 1-octene.

When the matrix component (a1) is a copolymer of propylene, the amount of units derived from ethylene and/or one or more C₄-C₁₀ α-olefin(s) is more preferably less than 1.5 wt %, even more preferably less than 0.5 wt % of the component (a1) (minirandom copolymer). The preferred matrix component (a1) is a copolymer of propylene with ethylene, even more preferred is a propylene homopolymer matrix (a1).

Particularly preferred as elastomeric component (a2) are the copolymers of ethylene with one or more C₄-C₁₀ α-olefin(s). The most preferred component (a2) is an ethylene-butene-1 copolymer containing 50-95 wt % of ethylene derived units and consisting of 20-95 wt % of a crystalline fraction (I), with a polyethylene-type crystallinity, insoluble in xylene at room temperature, and for 50-80 wt % of an amorphous fraction (II), soluble in xylene at room temperature, containing 40-70 wt % of ethylene derived units. Optionally the elastomeric ethylene copolymer component (a2) can further comprise a diene. When present, the diene is typically in amounts ranging from 0.5 to 10 wt % with respect to the weight of copolymer (a2). The diene can be conjugated or not and is selected from butadiene, 1,4-hexadiene, 1,5-hexadiene, and ethylidene-norbornene-1, for example.

Particularly preferred is 1-butene in the rubber component (a2).

As above said the heterophasic polymer composition (a1)+(a2), is preferably obtained as a reactor blend of components (a1) and (a2) by sequential polymerization in two or more stages, using highly stereospecific Ziegler-Natta catalysts.

Preferably component (a1) is prepared before component (a2).

The process comprising at least two sequential polymerization stages with each subsequent polymerization being conducted in the presence of the polymeric material formed in the immediately preceding polymerization reaction, wherein the polymerization stage of propylene to the polymer component (a1) is carried out in at least one stage, then at least one copolymerization stage of mixtures of ethylene with propylene and/or one or more C₄-C₁₀ α-olefin(s) to the elastomeric polymer component (a2) is carried out. The polymerisation stages can be carried out in the presence of a stereospecific Ziegler-Natta catalyst.

According to a preferred embodiment, all the polymerisation stages are carried out in the presence of a catalyst comprising a trialkylaluminium compound, optionally an electron donor, and a solid catalyst component comprising a halide or halogen-alcoholate of Ti and an electron-donor compound supported on anhydrous magnesium chloride. Catalysts having the above-mentioned characteristics are well known in the patent literature; particularly advantageous are the catalysts described in U.S. Pat. No. 4,399,054 and EP-A-45 977. Other examples can be found in U.S. Pat. No. 4,472,524.

Preferably the polymerisation catalyst is a Ziegler-Natta catalyst comprising a solid catalyst component comprising:

a) Mg, Ti and halogen and an electron donor (internal donor),

b) an alkylaluminum compound and, optionally (but preferably),

c) one or more electron-donor compounds (external donor).

The internal donor is preferably selected from the esters of mono or dicarboxylic organic acids such as benzoates, malonates, phthalates and certain succinates. They are described in U.S. Pat. No. 4522930, European patent 45977 and international patent applications WO 00/63261 and WO 01/57099, for example. Particularly suited are the phthalic acid esters and succinate acids esters. Alkylphthalates are preferred, such as diisobutyl, dioctyl and diphenyl phthalate and benzyl-butyl phthalate.

Among succinates, they are preferably selected from succinates of formula (I) below:

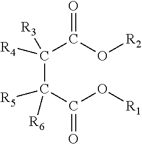

wherein the radicals R₁ and R₂, equal to, or different from, each other are a C₁-C₂₀ linear or branched alkyl, alkenyl, cycloalkyl, aryl, arylalkyl or alkylaryl group, optionally containing heteroatoms; the radicals R₃ to R₆ equal to, or different from, each other, are hydrogen or a C₁-C₂₀ linear or branched alkyl, alkenyl, cycloalkyl, aryl, arylalkyl or alkylaryl group, optionally containing heteroatoms, and the radicals R₃ to R₆ which are joined to the same carbon atom can be linked together to form a cycle; with the proviso that when R₃ to R₅ are contemporaneously hydrogen, R₆ is a radical selected from primary branched, secondary or tertiary alkyl groups, cycloalkyl, aryl, arylalkyl or alkylaryl groups having from 3 to 20 carbon atoms; or of formula (II) below:

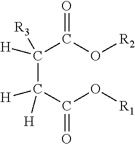

wherein the radicals R₁ and R₂, equal to or different from each other, are a C₁-C₂₀ linear or branched alkyl, alkenyl, cycloalkyl, aryl, arylalkyl or alkylaryl group, optionally containing heteroatoms and the radical R₃ is a linear alkyl group having at least four carbon atoms optionally containing heteroatoms.

The Al-alkyl compounds used as co-catalysts comprise Al-trialkyls, such as Al-triethyl, Al-triisobutyl, Al-tri-n-butyl, and linear or cyclic Al-alkyl compounds containing two or more Al atoms bonded to each other by way of O or N atoms, or SO₄ or SO₃ groups. The Al-alkyl compound is generally used in such a quantity that the Al/Ti ratio be from 1 to 1000.

The external donor (c) can be of the same type or it can be different from the succinates of formula (I) or (II). Suitable external electron-donor compounds include silicon compounds, ethers, esters such as phthalates, benzoates, succinates also having a different structure from those of formula (I) or (II), amines, heterocyclic compounds and particularly 2,2,6,6-tetramethylpiperidine, ketones and the 1,3-diethers of the general formula (III):

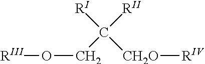

wherein R^{I} and R^{II} are the same or different and are C₁-C₁₈ alkyl, C₃-C₁₈ cycloalkyl or C₇-C₁₈ aryl radicals; R^{III} and R^{IV} are the same or different and are C₁-C₄ alkyl radicals; or the 1,3-diethers in which the carbon atom in position 2 belongs to a cyclic or polycyclic structure made up of 5, 6 or 7 carbon atoms and containing two or three unsaturations.

Ethers of this type are described in published European patent applications 361493 and 728769.

Preferred electron-donor compounds that can be used as external donors include aromatic silicon compounds containing at least one Si—OR bond, where R is a hydrocarbon radical. A particularly preferred class of external donor compounds is that of silicon compounds of formula Rₐ⁷R_{b}⁸Si(OR⁹)_{c}, where a and b are integer from 0 to 2, c is an integer from 1 to 3 and the sum (a+b+c) is 4; R⁷, R⁸, and R⁹, are C1-C18 hydrocarbon groups optionally containing heteroatoms. Particularly preferred are the silicon compounds in which a is 1, b is 1, c is 2, at least one of R⁷ and R⁸ is selected from branched alkyl, alkenyl, alkylene, cycloalkyl or aryl groups with 3-10 carbon atoms optionally containing heteroatoms and R⁹ is a C₁-C₁₀ alkyl group, in particular methyl. Examples of such preferred silicon compounds are cyclohexyltrimethoxysilane, t-butyltrimethoxysilane, t-hexyltrimethoxysilane, cyclohexylmethyldimethoxysilane, 3,3,3-trifluoropropyl-2-ethylpiperidyl-dimethoxysilane, diphenyldimethoxysilane, methyl-t-butyldimethoxysilane, dicyclopentyldimethoxysilane, 2-ethylpiperidinyl-2-t-butyldimethoxysilane, (1,1,1-trifluoro-2-propyl)-methyldimethoxysilane and (1,1,1-trifluoro-2-propyl)-2-ethylpiperidinyldimethoxysilane. Moreover, are also preferred the silicon compounds in which a is 0, c is 3, R⁸ is a branched alkyl or cycloalkyl group, optionally containing heteroatoms, and R⁹ is methyl. Particularly preferred specific examples of silicon compounds are (tert-butyl)₂Si(OCH₃)₂, (cyclohexyl)(methyl) Si(OCH₃)₂, (phenyl)₂Si(OCH₃)₂ and (cyclopentyl)₂SKOCH₃)₂.

Preferably the electron donor compound (c) is used in such an amount to give a molar ratio between the organoaluminum compound and said electron donor compound (c) of from 0.1 to 500, more preferably from 1 to 300 and in particular from 3 to 30.

As explained above, the solid catalyst component comprises, in addition to the above electron donors, Ti, Mg and halogen. In particular, the catalyst component comprises a titanium compound, having at least a Ti-halogen bond and the above mentioned electron donor compounds supported on a Mg halide. The magnesium halide is preferably MgCl₂ in active form, which is widely known from the patent literature as a support for Ziegler-Natta catalysts. Patents U.S. Pat. No. 4,298,718 and U.S. Pat. No. 4,495,338 were the first to describe the use of these compounds in Ziegler-Natta catalysis. It is known from these patents that the magnesium dihalides in active form used as support or co-support in components of catalysts for the polymerisation of olefins are characterized by X-ray spectra in which the most intense diffraction line that appears in the spectrum of the non-active halide is diminished in intensity and is replaced by a halo whose maximum intensity is displaced towards lower angles relative to that of the more intense line.

The preferred titanium compounds are TiCl₄ and TiCl₃; furthermore, also Ti-haloalcoholates of formula Ti(OR)n-yXy can be used, where n is the valence of titanium, y is a number between 1 and n, X is halogen and R is a hydrocarbon radical having from 1 to 10 carbon atoms.

The preparation of the solid catalyst component can be carried out according to several methods, well known and described in the art.

According to a preferred method, the solid catalyst component can be prepared by reacting a titanium compound of formula Ti(OR)n-yXy, where n is the valence of titanium and y is a number between 1 and n, preferably TiCl₄, with a magnesium chloride deriving from an adduct of formula MgCl₂.pROH, where p is a number between 0.1 and 6, preferably from 2 to 3.5, and R is a hydrocarbon radical having 1-18 carbon atoms. The adduct can be suitably prepared in spherical form by mixing alcohol and magnesium chloride in the presence of an inert hydrocarbon immiscible with the adduct, operating under stirring conditions at the melting temperature of the adduct (100-130° C.). Then, the emulsion is quickly quenched, thereby causing the solidification of the adduct in form of spherical particles.

Examples of spherical adducts prepared according to this procedure are described in U.S. Pat. No. 4,399,054 and U.S. Pat. No. 4,469,648. The so obtained adduct can be directly reacted with the Ti compound or it can be previously subjected to thermally controlled dealcoholation (80-130° C.) so as to obtain an adduct in which the number of moles of alcohol is generally lower than 3, preferably between 0.1 and 2.5. The reaction with the Ti compound can be carried out by suspending the adduct (dealcoholated or as such) in cold TiCl₄ (generally 0° C.); the mixture is heated up to 80-130° C. and kept at this temperature for 0.5-2 hours. The treatment with TiCl₄ can be carried out one or more times. The electron donor compound(s) can be added during the treatment with TiCl₄.

Regardless of the preparation method used, the final amount of the electron donor compound(s) is preferably such that the molar ratio with respect to the MgCl₂ is from 0.01 to 1, more preferably from 0.05 to 0.5.

The catalysts may be precontacted with small quantities of olefin (prepolymerisation), maintaining the catalyst in suspension in a hydrocarbon solvent, and polymerising at temperatures from ambient to 60° C., thus producing a quantity of polymer from 0.5 to 3 times the weight of the catalyst. The operation can also take place in liquid monomer, producing, in this case, a quantity of polymer 1000 times the weight of the catalyst.

By using the above mentioned catalysts, the polyolefin compositions are obtained in spheroidal particle form, the particles having an average diameter from about 250 to 7,000 μm, a flowability of less than 30 seconds and a bulk density (compacted) greater than 0.4 g/ml.

The polymerisation stages may occur in liquid phase, in gas phase or liquid-gas phase. Preferably, the polymerisation of the polymer component 1) is carried out in liquid monomer (e.g. using liquid propylene as diluent), while the copolymerisation stages of the elastomeric copolymer component 2) is carried out in gas phase. Alternatively, all the sequential polymerisation stages can be carried out in gas phase.

The reaction temperature in the polymerisation stage for the preparation of the polymer component 1) and in the preparation of the elastomeric copolymer component 2) may be the same or different, and is preferably from 40 to 100° C.; more preferably, the reaction temperature ranges from 50 to 80° C. in the preparation of polymer component 1), and from 70 to 100° C. for the preparation of polymer component 2).

The pressure of the polymerisation stage to prepare polymer component 1), if carried out in liquid monomer, is the one which competes with the vapor pressure of the liquid propylene at the operating temperature used, and it may be modified by the vapor pressure of the small quantity of inert diluent used to feed the catalyst mixture, by the overpressure of optional monomers and by the hydrogen used as molecular weight regulator.

The polymerisation pressure preferably ranges from 33 to 43 bar, if done in liquid phase, and from 5 to 30 bar if done in gas phase. The residence times relative to the stages depend on the desired ratio between polymer components 1) and 2), and can usually range from 15 minutes to 8 hours. Conventional molecular weight regulators known in the art, such as chain transfer agents (e.g. hydrogen or ZnEt₂), may be used.

The component (b) is a butene-1 (co) polymer typically exhibiting from elastomeric to plastomeric behaviour and can be a homopolymer or a copolymer of butene-1 with one or more α-olefins, or a composition of copolymers of butene-1 with other alfa-olefins. Preferred as α-olefins, which are or may be present as comonomers in the component (b) of the compositions of the invention, are ethylene, propylene, 1-pentene, 1-hexene, 4-methyl-1-pentene and 1-octene. Particularly preferred as comonomers are propylene and ethylene.

Component (b) has preferably shore A hardness (ISO868) equal to or less than 90 points, preferably lower than 70 even more preferably lower than 60 points.

The Component (b) is preferably selected from the group consisting of:
(b1) a butene-1 homopolymer or copolymer of butene-1 with at least another α-olefin, preferably with propylene as comonomer, having the following properties:
   percentage of isotactic pentads (mmmm %) from 25 to 55%, preferably from 35 to 55%;
   intrinsic viscosity [11] measured in tetraline at 135° C. from 0.5 to 3 dL/g, preferably from 1 to 2.5 dL/g;
   xylene insoluble fraction at 0° C. from 2 to 60 wt %, preferably from 3 to 20 wt %, more preferably less than 10 wt %;
(b2) a butene-1 polymer having the following properties:
   distribution of molecular weights (Mw/Mn) measured by GPC lower than 3.5 preferably lower than 3;
   preferably no melting point (TmII) detectable at the DSC, measured according to the DSC method described herein below;
   optionally a measurable melting enthalpy (ΔHf) after aging. Particularly, the melting enthalpy of (b2) measured after 10 days of aging at room temperature, when present, is of less than 25 J/g, preferably of from 4 to 20 J/g.

The butene-1 (co)polymers (b1) of the present invention can be prepared by polymerization of the monomers in the presence of a low stereospecificity Ziegler-Natta catalyst comprising (A) a solid component comprising a Ti compound and an internal electron-donor compound supported on MgCl₂; (B) an alkylaluminum compound and, optionally, (C) an external electron-donor compound. In a preferred aspect of the process for the preparation of the (co)polymers (b1) of the invention, the external electron donor compound is not used in order not to increase the stereoregulating capability of the catalyst. In cases in which the external donor is used, its amount and modalities of use should be such as not to generate a too high amount of highly stereoregular polymer such as it is described in the International application WO02006/042815 A1. The butene-1 copolymers (b1) have typically a distribution of molecular weights (Mw/Mn) measured by GPC higher than 3.5, preferably higher than 4.

The polymerization process for butene-1 (co)polymers (b1) can be carried out according to known techniques, for example slurry polymerization using as diluent a liquid inert hydrocarbon, or solution polymerization using for example the liquid butene-1 as a reaction medium. Moreover, it may also be possible to carry out the polymerization process in the gas-phase, operating in one or more fluidized or mechanically agitated bed reactors. The polymerization carried out in the liquid butene-1 as a reaction medium is highly preferred.

The polymerization is generally carried out at temperature of from 20 to 120° C., preferably of from 40 to 90° C. The polymerization can be carried out in one or more reactors that can work under same or different reaction conditions such as concentration of molecular weight regulator, comonomer concentration, external electron donor concentration, temperature, pressure etc.

The butene-1 polymer (b2) can be a butene-1/ethylene polymer or a butene-1/ethylene/propylene polymer obtained by contacting under polymerization conditions butene-1 and ethylene and eventually propylene in the presence of a metallocene catalyst system obtainable by contacting:
(A) a stereorigid metallocene compound;
(B) an alumoxane or a compound capable of forming an alkyl metallocene cation; and, optionally,
(C) an organo aluminum compound.

Examples of such butene-1 metallocene copolymers (b2), catalyst and process can be found in WO 2004/099269 and WO 2009/000637.

The process for the polymerization of butene-1 polymer (b2) according to the invention can be carried out in the liquid phase in the presence or absence of an inert hydrocarbon solvent, such as in slurry, or in the gas phase. The hydrocarbon solvent can either be aromatic such as toluene, or aliphatic such as propane, hexane, heptane, isobutane or cyclohexane. Preferably the polymers (b2) of the present invention are obtained by a solution process, i.e. a process carried out in liquid phase wherein the polymer is completely or partially soluble in the reaction medium.

As a general rule, the polymerization temperature is generally comprised between −100° C. and +200° C. preferably comprised between 40° and 90° C., more preferably between 50° C. and 80° C. The polymerization pressure is generally comprised between 0.5 and 100 bar.

The lower the polymerization temperature, the higher are the resulting molecular weights of the polymers obtained.

The butene-1 polymer (b2) can be advantageously also a composition consisting of:
i) 80 wt % or more of a butene-1 polymer having the above said properties of (b2),
ii) up to 20 wt % of a crystalline propylene polymer provided that the total content of ethylene and/or propylene derived units in the composition (i)+(ii) are present in amounts equal to or less than 25 wt %.

The overall handability of the metallocene plastomer (i) can be advantageously improved by in line compounding up to 20 wt % of the said crystalline propylene polymer component (ii), without substantial deterioration of other mechanical properties. The crystalline propylene polymer has tipically a value of melt flow rate (MFR) at 230° C., 2.16 kg of from 2 to 10 g/10 min, melting temperature DSC of from 130° C. to 160° C.

The polyolefin composition according to the present invention can be prepared according to conventional methods, for examples, mixing component (a), and component (b) and well known additives in a blender, such as a Henschel or Banbury mixer, to uniformly disperse the said components, at a temperature equal to or higher than the polymer softening temperature, then extruding the composition and pelletizing. Conventional additives, fillers and pigments, commonly used in olefin polymers, may be added, such as nucleating agents, extension oils, mineral fillers, and other organic and inorganic pigments. In particular, the addition of inorganic fillers, such as talc, calcium carbonate and mineral fillers, also brings about an improvement to some mechanical properties, such as flexural modulus and HDT. Talc can also have a nucleating effect.

As previously said, the heat-sealable film according to the invention comprises at least one sealing layer. Thus it can be a mono-layer film, but preferably it is multilayer, and in particular it comprises at least one support layer composed of or comprising a polymeric material, in particular a polyolefin material.

The support layer or layers can be composed of or comprise one or more polymers or copolymers, or their mixtures, of R—CH═CH₂ olefins where R is a hydrogen atom or a C1-C6 alkyl radical, as for instance 1-butene, 1-hexene, 1-octene, 4-methyl-1-pentene. Particularly preferred are the following polymers:
1) isotactic or mainly isotactic propylene homopolymers;
2) random copolymers of propylene with ethylene and/or C4-C8 α-olefins, such as for example 1-butene, 1-hexene, 1-octene, 4-methyl-1-pentene, wherein the total comonomer content ranges from 0.05 wt % to 20 wt %, or mixtures of said copolymers with isotactic or mainly isotactic propylene homopolymers;
3) heterophasic copolymers comprising (a) a propylene homopolymer and/or one of the copolymers of item 2), and an elastomeric fraction (b) comprising copolymers of ethylene with propylene and/or a C4-C8 α-olefin, optionally containing minor amounts of a diene, such as butadiene, 1,4-hexadiene, 1,5-hexadiene, ethylidene-1-norbornene.

Preferably the amount of diene in (3) is from 1 to 10 wt %.

The heterophasic copolymers (3) are prepared according to known methods by mixing the components in the molten state, or by sequential copolymerization, and generally contain the copolymer fraction (b) in amounts ranging from 5 to 80 wt %.

Other olefin polymers employable for the support layers are HDPE, LDPE and LLDPE polyethylenes.

Examples of polymeric materials different from polyolefins, employable for the support layers, are polystyrenes, polyvinylchlorides, polyamides, polyesters and polycarbonates.

Both the support layers and the heat-sealable layers may comprise additives commonly employed in the art, like stabilizers, pigments, fillers, nucleating agents, slip agents, lubricant and antistatic agents, flame retardants, plasticizers and biocidal agents.

Preferred structures for said films are of A/B type and A/B/A type, where A is the heat-sealable layer according to the present invention and B is the support layer.

For blown films the thickness of the layers of heat-sealing composition according to the present invention is preferably from 5 to 15 μm, while the thickness of the support layers is preferably from 15 to 65 μm. The overall thickness of the said films is preferably of from 20 to 80 μm.

For cast films the thickness of the layers of heat-sealing composition according to the present invention is preferably from 1 to 100 μm, more preferably from 5 to 20 μm, while the thickness of the support layers is preferably from 20 to 200 μm, preferably from 30 to 100 μm. The overall thickness of the said films is preferably of from 20 to 300 μm.

The said packaging films are produced by using processes well known in the art.

In particular, extrusion processes can be used.

In said extrusion processes the polymer materials to be used for the heat-sealing layers and those to be used for the support layers are molten in different extruders and extruded through a narrow slit.

The extruded molten material is pulled away from the slit and cooled before winding-up. Specific examples of extrusion processes are the blown film and cast film processes hereinbelow explained.

Blown Film

The molten polymer materials are forced through a circular shaped slit.

The extrudate which is drawn off has the shape of a tube, which is inflated by air to form a tubular bubble. The bubble is cooled and collapsed before winding-up.

Cast Film

The molten polymer materials are forced through a long, thin, rectangular shaped slit. The extrudate has the shape of a thin film. The film is cooled before winding-up.

The following examples are given to illustrate, not to limit, the present invention.

The following analytical methods have been used to determine the properties reported in the present application.
Comonomer contents: determined by IR spectroscopy or by NMR (when specified). Particularly for the butene-1 copolymers component (b) the amount of comonomers was calculated from ¹³C-NMR spectra of the copolymers of the examples. Measurements were performed on a polymer solution (8-12 wt %) in dideuterated 1,1,2,2-tetrachloro-ethane at 120° C. The ¹³C NMR spectra were acquired on a Bruker AV-600 spectrometer operating at 150.91 MHz in the Fourier transform mode at 120° C. using a 90° pulse, 15 seconds of delay between pulses and CPD (WALTZ16) to remove ¹H—¹³C coupling. About 1500 transients were stored in 32K data points using a spectral window of 60 ppm (0-60 ppm).

Copolymer Composition
Diad distribution is calculated from ¹³C NMR spectra using the following relations:

PP=100 I₁/Σ

PB=100 I₂/Σ

BB=100(I₃−I₁₉)/Σ

PE=100(I₅+I₆)/Σ

BE=100(I₉+I₁₀)/Σ

EE=100(0.5(I₁₅+I₆+I₁₀)+0.25(I₁₄))/Σ

Where Σ=I₁+I₂+I₃−I₁₉+I₅+I₆+I₉+I₁₀+0.5(₁₅+I₆+I₁₀)+0.25(I₁₄)
The molar content is obtained from diads using the following relations:

P(m %)=PP+0.5(PE+PB)

B(m %)=BB+0.5(BE+PB)

EE(m %)=EE+0.5(PE+BE)
I₁, I₂, I₃, I₅, I₆, I₉, I₆, I₁₀, I₁₄, I₁₅, I₁₉ are integrals of the peaks in the ¹³C NMR spectrum (peak of EE sequence at 29.9 ppm as reference). The assignments of these peaks are made according to J. C. Randal, Macromol. Chem Phys., C29, 201 (1989), M. Kakugo, Y. Naito, K. Mizunuma and T. Miyatake, Macromolecules, 15, 1150, (1982), and H. N. Cheng, Journal of Polymer Science, Polymer Physics Edition, 21, 57 (1983). They are collected in Table A (nomenclature according to C. J. Carman, R. A. Harrington and C. E. Wilkes, Macromolecules, 10, 536 (1977)).

TABLE A

| I | Chemical Shift (ppm) | Carbon | Sequence |
|---|---|---|---|
| 1 | 47.34-45.60 | S_{αα} | PP |
| 2 | 44.07-42.15 | S_{αα} | PB |
| 3 | 40.10-39.12 | S_{αα} | BB |
| 4 | 39.59 | T_{δδ} | EBE |
| 5 | 38.66-37.66 | S_{αγ} | PEP |
| 6 | 37.66-37.32 | S_{αδ} | PEE |
| 7 | 37.24 | T_{βδ} | BBE |
| 8 | 35.22-34.85 | T_{ββ} | XBX |
| 9 | 34.85-34.49 | S_{αγ} | BBE |
| 10 | 34.49-34.00 | S_{αδ} | BEE |
| 11 | 33.17 | T_{δδ} | EPE |
| 12 | 30.91-30.82 | T_{βδ} | XPE |
| 13 | 30.78-30.62 | S_{γγ} | XEEX |
| 14 | 30.52-30.14 | S_{γδ} | XEEE |
| 15 | 29.87 | S_{δδ} | EEE |
| 16 | 28.76 | T_{ββ} | XPX |
| 17 | 28.28-27.54 | 2B₂ | XBX |
| 18 | 27.54-26.81 | S_{βδ} + 2B₂ | BE, PE, BBE |
| 19 | 26.67 | 2B₂ | EBE |
| 20 | 24.64-24.14 | S_{ββ} | XEX |
| 21 | 21.80-19.50 | CH₃ | P |
| 22 | 11.01-10.79 | CH₃ | B |

Fractions soluble and insoluble in xylene at 25° C. (XS 25° C.): 2.5 g of polymer are dissolved in 250 mL of xylene at 135° C. under agitation. After 20 minutes the solution is allowed to cool to 25° C., still under agitation, and then allowed to settle for 30 minutes. The precipitate is filtered with filter paper, the solution evaporated in nitrogen flow, and the residue dried under vacuum at 80° C. until constant weight is reached. Thus one calculates the percent by weight of polymer soluble (Xylene Solubles—XS) and insoluble at room temperature (25° C.).
The percent by weight of polymer insoluble in xylene at ambient temperature is considered the isotactic index of the polymer. This value corresponds substantially to the isotactic index determined by extraction with boiling n-heptane, which by definition constitutes the isotactic index of polypropylene.
Fractions soluble and insoluble in xylene at 0° C. (XS 0° C.): 2.5 g of the butene-1 (co)polymers (component (b)) are dissolved in 250 ml of xylene at 135° C. under agitation. After 30 minutes the solution is allowed to cool to 100° C., still under agitation, and then placed in a water and ice bath to cool down to 0° C. Than, the solution is allowed to settle for 1 hour in the water and ice bath. The precipitate is filtered with filter paper. During the filtering, the flask is left in the water and ice bath so as to keep the flask inner temperature as near to 0° C. as possible. Once the filtering is finished, the filtrate temperature is balanced at 25° C., dipping the volumetric flask in a water-flowing bath for about 30 minutes and then, divided in two 50 ml aliquots. The solution aliquots are evaporated in nitrogen flow, and the residue dried under vacuum at 80° C. until constant weight is reached. The weight difference in between the two residues must be lower than 3%; otherwise the test has to be repeated. Thus, one calculates the percent by weight of polymer soluble (Xylene Solubles at 0° C.=XS 0° C.) from the average weight of the residues. The insoluble fraction in o-xylene at 0° C. (xylene Insolubles at 0° C.=XI 0° C.) is:

XI /%0° C.=100−XS %0° C.
Melt flow rate: Determined according to ISO method 1133 at 230° C. and 2.16 kg (condition L) where not differently specified.
Intrinsic Viscosity [η]: Measured in tetrahydronaphthalene (tetralin) at 135° C. (ASTM D 2857).
Flexural modulus: Determined according to ISO method 178.

Tg Determination Via DMTA Analysis
Molded specimen of 76 mm by 13 mm by 1 mm are fixed to the DMTA machine for tensile stress. The frequency of the tension and relies of the sample is fixed at 1 Hz. The DMTA translate the elastic response of the specimen starting form −100° C. to 130° C. In this way it is possible to plot the elastic response versus temperature. The elastic modulus for a viscoelastic material is defined as E=E′+iE″. The DMTA can split the two components E′ and E” by their resonance and plot E′ vs temperature and E′/E″=tan (δ) vs temperature. The glass transition temperature Tg is assumed to be the temperature at the maximum of the curve E′/E″=tan (δ) vs temperature.

Determination of X-Ray Crystallinity
The X-ray crystallinity was measured with an X-ray Diffraction Powder Diffractometer using the Cu—Kα1 radiation with fixed slits and collecting spectra between diffraction angle 2Θ=5° and 2Θ=35° with step of 0.1° every 6 seconds.
Measurement were performed on compression molded specimens in the form of disks of about 1.5-2.5 mm of thickness and 2.5-4.0 cm of diameter. These specimens are obtained in a compression molding press at a temperature of 200° C.±5° C. without any appreciable applied pressure for 10 minutes. Then applying a pressure of about 10 Kg/cm² for about few second and repeating this last operation for 3 times.
The diffraction pattern was used to derive all the components necessary for the degree of cristallinity by defining a suitable linear baseline for the whole spectrum and calculating the total area (Ta), expressed in counts/sec·2Θ, between the spectrum profile and the baseline. Then a suitable amorphous profile was defined, along the whole spectrum, that separate, according to the two phase model, the amorphous regions from the crystalline ones. Thus it is possible to calculate the amorphous area (Aa), expressed in counts/sec·2Θ, as the area between the amorphous profile and the baseline; and the cristalline area (Ca), expressed in counts/sec·2Θ, as Ca=Ta−Aa
The degree of cristallinity of the sample was then calculated according to the formula:

% Cr=100×Ca/Ta
The thermal properties (melting temperatures and entalpies) were determined by Differential Scanning Calorimetry (D.S.C.) on a Perkin Elmer DSC-7 instrument. The melting temperatures of butene-1 homo and co-polymers were determined according to the following method:
   TmII (measured in second heating run):A weighted sample (5-10 mg) obtained from the polymerization was sealed into aluminum pans and heated at 200° C. with a scanning speed corresponding to 20° C./minute. The sample was kept at 200° C. for 5 minutes to allow a complete melting of all the crystallites. Successively, after cooling to −20° C. with a scanning speed corresponding to 10° C./minute, the peak temperature was taken as crystallization temperature (Tc). After standing 5 minutes at -20° C., the sample was heated for the second time at 200° C. with a scanning speed corresponding to 10° C./min. In this second heating run, the peak temperature was taken as the melting temperature of the PB-1 crystalline form II (TmII) and the area as global melting enthalpy (ΔHfII).
   The melting enthalpy after 10 days was measured as follows by using the Differential Scanning Calorimetry (D.S.C.) on an Perkin Elmer DSC-7 instrument: A weighted sample (5-10 mg) obtained from the polymerization was sealed into aluminum pans and heated at 200° C. with a scanning speed corresponding to 20° C./minute. The sample was kept at 200° C. for 5 minutes to allow a complete melting of all the crystallites. The sample was then stored for 10 days at room temperature. After 10 days the sample was subjected to DSC, it was cooled to −20° C., and then it was heated at 200° C. with a scanning speed corresponding to 10° C./min. In this heating run, the first peak temperature coming from the lower temperature side in the thermogram was taken as the melting temperature (Tm), and the area as global melting enthalpy after 10 days (ΔHf), when this was the only peak observed.
   The melting temperature of crystalline form I (TmI) can also be measured in this condition when present either as a shoulder peak in the (Tm) peak or as a distinct peak at higher temperatures. When present a propylene crystallinity coming from addition of a polypropylene polymer further melting temperature peaks (PP) can be detected at higher temperatures.
Determination of isotactic pentads content: 50 mg of each sample were dissolved in 0.5 mL of C₂D₂Cl₄.
The ¹³C NMR spectra were acquired on a Bruker DPX-400 (100.61 Mhz, 90° pulse, 12s delay between pulses). About 3000 transients were stored for each spectrum; mmmm pentad peak (27.73 ppm) was used as reference.
The microstructure analysis was carried out as described in literature (Macromolecules 1991, 24, 2334-2340, by Asakura T. et Al. and Polymer, 1994, 35, 339, by Chujo R. et Al.).
The percentage value of pentad tacticity (mmmm %), provided in the experimental part for butene-1 homo and copolymers, is the percentage of stereoregular pentads (isotactic pentad) as calculated from the relevant pentad signals (peak areas) in the NMR region of branched methylene carbons (around 27.73 ppm assigned to the BBBBB isotactic sequence), with due consideration of the superposition between stereoirregular pentads and of those signals, falling in the same region, due to the alfa-olefin comonomer (e.g propylene derived units when present).
Molecular weight ( M̅ₙ, M̅_{w}, M̅_{z} and M̅_{w}/ M̅ₙ): Measured by way of gel permeation chromatography (GPC) using a Waters 150-C ALC/GPC system equipped with a TSK column set (type GMHXL-HT) working at 135° C. with 1,2-dichlorobenzene as solvent (ODCB) (stabilized with 0.1 vol. of 2, 6-di-t-butyl p-cresole (BHT)) at flow rate of 1 ml/min. The sample is dissolved in ODCB by stirring continuously at a temperature of 140° C. for 1 hour. The solution is filtered through a 0.45 μm Teflon membrane. The filtrate (concentration 0.08-1.2 g/l injection volume 300 μl) is subjected to GPC. Monodisperse fractions of polystyrene (provided by Polymer Laboratories) were used as standard. The universal calibration for PB copolymers was performed by using a linear combination of the Mark-Houwink constants for PS (K=7.11×10−5 dl/g; a=0. 743) and PB(K=1.18×10−4 dl/g; α=0.725).
Density: According to ISO 1183. The method ISO is based on observing the level to which a test specimen sinks in a liquid column exhibiting a density gradient.
Standard specimens are cut from strands extruded from a grader (MFR measurement). The polybutene-1 specimen is putted in an autoclave at 2000 bar for 10 min at a room temperature in order to accelerate the transformation phase of the polybutene. Then, the specimen is inserted in the gradient column where density is measured according to ISO 1183.

Preparation of the Film Specimens

Cast films have been prepared by extruding each test composition in a single screw Dr. Collin cast film extruder equipped with a three layers co-extrusion cast film line, at a melt temperature of 190-250° C. The throughput was ca.18.5 kg/h. The cast film has been winded at a film drawing speed between 12 and 13m/min with a nominal thickness of 80 μm, which is the final specimen thickness. Some films were produced in the same way also with a nominal thickness of 70 μm and drawing speed ca. 17 m/min.

Blown films have been prepared by extruding each test composition in a single screw Dr. Collin extruder equipped with a three layers co-extrusion blown film line at a melt temperature of 200-230° C. The throughput was ca.14 kg/h. The extruder is equipped with an annular die with a diameter 80 mm and having a die gap 0.8 mm. The films are cooled by mean of a dual flow cooling ring with cooling air at ambient temperature. The bubble is layed-flat and winded at a film drawing speed of 5 m/min. The films are produced with a bubble wall thickness of 70 μm, which is the final specimen thickness.

Optical Properties on Film
Clarity: measured according to ASTM D 1746-70
Haze on film: measured according to ISO 14782
Gloss on film: measured according to ASTM D523 and D2457

Tensile Properties on Film in Machine (MD) and Transverse (TD) Direction
Stress: measured according to ASTM D882
Elongation: measured according to ASTM D882
Tear resistance (Elmendorf): measured according to ASTM D1922

Seal strength was measured in (N/15 mm) with reference to ASTM F2029/ASTM F88. For each test two of the above prepared film specimens (same sample composition and thickness) are superimposed in alignment, the adjacent layers being layers of the particular test composition. The superimposed specimens are sealed in transverse direction with a RDM Sealer, model HSE-3 multi seal. Sealing time is 1.2 seconds at a pressure of 5 bars. The sealing temperature is increased for each seal, starting from 30° C. The sealed samples are left to cool and stored 24 h under Standard conditions (23° C. and 50% relative humidity). The sealed samples are cut in 15 mm wide strips, which unsealed ends are attached to an Instron machine, where they are tested at a traction speed of 100 mm/min with an initial distance between the grips of 50 mm. The maximum force measured during the tensile test is defined as the seal strength.

The procedure for the test after sterilization (retort) is the same as above with the only difference that the sealed samples have been sterilized in autoclave at 121° C. for 60 min. before the seal strength tensile measurement. After the sterilization and before the tensile test the sealed samples are left to cool and stored 24h under standard conditions (23° C. and 50% relative humidity).

### PRODUCTS USED IN WORKING EXAMPLES

In table la it is reported the structure and properties of the heterophasic composition component (a) (HECO1) and (HECO2) each consisting of a crystalline propylene homopolymer matrix (a1) and an elastomeric component (a2).

In table 1b it is reported the structure and properties of the butene-1 (co)polymers (PB1, PB2).

PB1 is a butene-1/propylene copolymer. PB1 is a (b1) component prepared according to the process described in the International application WO02006/042815 A1.

PB2 is a metallocene butene-1/ethylene copolymer (b2) prepared according to the process described in WO 2009/000637.

To improve handability of the plastomer, PB2 was further blended, by in-line compounding, with a component (ii) commercial crystalline terpolymer of propylene with ethylene and butene-1 (having Melt flow rate (MFR) (230° C./2.16 Kg-ISO 1133) 6 g/10 min; and Melting temperature (DSC) of 132° C. The final structure and properties of the blend PB3=PB2+(ii) used as component (b) according to the present invention is also reported in table 1b.

TABLE 1a
HECO materials

| Heterophasic copolymers | | HECO2 | HECO1 |
|---|---|---|---|
| Matrix component (a1) | Type | Homopolymer | Homopolymer |
| Split | wt % | 83 | 83 |
| MFR“L” (230° C.; 2.16 | g/10 min | 3 | n.a. |
| Kg) | | | |
| XSm (25° C.) | wt % | 1.5 | 2.5 |
| Elastomer component (a2) | Type | C2C4 | C2C3 |
| Split | wt % | 17 | 17 |
| C2 in rubber (bipo) | wt % | 75 | 58 |
| XSrub* (25° C.) | wt % | 65.9 | 78.8 |

Final Composition (a1) + (a2)

| | | | |
|---|---|---|---|
| MFR “L” (230° C.; | g/10 min | 3.5 | 0.7 |
| 2.16 Kg) | | | |
| C2 content | wt % | 13.1 | 10 |
| C4 content | wt % | 4.3 | — |
| XStot (25° C.) | wt % | 12.4 | 15.5 |
| Intrinsic Viscosity of the | dl/g | 1.49 | 2.8 |
| total Xylene Soluble | | | |
| fraction at 25° C. (XSIVtot) | | | |
| Tm-DSC** | ° C. | 160 | 161 |

*calculated form XStot and Xsm.
**in absence of nucleating agent the melting temperature peak is substantially equal to the matrix melting temperature

TABLE 1b
Butene-1 (co)polymer component (b)

| | | PB1 | PB2 | PB3 |
|---|---|---|---|---|
| Type | | C4C3 | C4C2 | C4C2C3** |
| C3 comonomer content | wt % | 3.9 | — | 12.8 |
| (NMR) | | | | |
| C2 comonomer content | wt % | — | 8.5 | 9.2 |
| (NMR) | | | | |
| Intrinsic Viscosity | dl/g | 2.3 | 1.8 | 2.1 |
| Melt Flow Rate - @ | g/10 min | 0.5 | 1.5 | 1.4 |
| 190/2.16 | | | | |
| Density | g/cc | 0.878 | 0.874 | 0.873 |
| Flexural elastic modulus | MPa | 31 | 10 | 12 |
| (ISO 178) | | | | |
| Hardness Shore A | | 78.8 | 54.4 | 64.5 |
| (ISO 868) | | | | |
| Tg (DMTA) | ° C. | −5.8 | na | −27 |
| % cristall. RX | % | 29 | 9 | na |
| DSC Tm | | | 40 | 38 (PB) |
| | | | | 158 (PP) |
| DSC Tm I | ° C. | 118 | | |
| DSC Tm II* | ° C. | 100 | nd | nd (PB) |
| | | | | 158 (PP) |
| S.X.0/0° C. Soluble Total | wt % | 96 | 95 | 92 |
| mmmm % | % | 51.3 | 90.6 | na |
| Mw/Mn | | 6.1 | 2 | 2.5 |
| ΔHf after 10 days | J/g | na | 6.7 | na |

nd = not detectable
na = not available
*in second heating run
**content propylene derived units (C3) comes from in-line compounding

In the following tables compositions and properties of the blends of component (a) and (b) according to the invention and comparative examples are reported.

### EXAMPLES

Component (a) and (b) are dry-blended in amount as indicated in the tables in the extruder directly equipped with a cast or blown film line as described in the preparation of the film specimens above.

### COMPARATIVE EXAMPLES

The same Component (a) used in the examples was blended with commercial ethylene based plastomers:
an ethylene-octene copolymer, Dow AFFINITY® PL 1850G, having 12 wt % octene derived units in the polymer, a density of 0.902 g/cc, and a melt index of 3.0 g/10 min (190° C./2.16 kg)
an ethylene-octene copolymer, Dow AFFINITY® PL 1880, having 12 wt % octene derived units in the polymer, a density of 0.902, and a melt index of 1.0 g/10 min (190° C./2.16 kg)

Amounts of components and properties of the films obtained from the compositions are reported in the tables under comparative examples 3c, 6c, 8c.

The comparative examples show that a different commercial plastomer (ethylene/octene copolymers) even providing a similar balance of physical-mechanical properties do not provide the same effect on heat sealability, particularly on cast film. The maximum seal strength is not increased as much as with the butene-1 polymers of the invention or it is even reduced with respect to the base material (from 135 to 160° C. in tables 2-5)

### REFERENCE EXAMPLES

The heterophasic compositions HECO1 and HECO2 where extruded (neat) and used for producing film specimens characterized as reference material. The properties are reported under reference examples ref 1 and ref 2 respectively.

Table 5 shows results obtained with low amount of butene-1 polymer added to the base heterophasic material (2-10 wt %, preferably less than 5 wt % of component (b) added in the composition according to the invention). Seal strength after sterilization is slightly reduced but film samples with the addition of the butene-1 polymers of the invention show equal or higher seal strength than the base material neat (ref 1 and ref 2 in tables 2-5)

TABLE 2
cast film samples from (HECO1) as base material component (a)

| Example | setting | Units | Ref 1 | 1 | 2 | 3c |
|---|---|---|---|---|---|---|
| Component (b) | | type | | PB1 | PB3 | Affinity |
| | | | | | | 1880 |
| Amount of (b) with respect to | | wt % | | 20 | 20 | 20 |
| weight of composition (a) + (b) | | | | | | |
| Clarity | | % | 30 | 18.7 | 16.5 | 39.9 |
| Film thickness nominal | | mm | 0.07 | 0.07 | 0.07 | 0.07 |
| Haze | | % | 43.1 | 54.9 | 56.7 | 32.8 |
| GLOSS on film (45′) Chill roll | | | 19.8 | 15 | 14.5 | 30.8 |
| layer | | | | | | |
| GLOSS on film (45′) external | | | 17.7 | 13.3 | 12.7 | 22.4 |
| layer | | | | | | |
| MD stress @ yield | | MPa | 18.4 | 14.5 | 14.2 | 17.8 |
| MD elongation @ yield | | % | 12.9 | 20.6 | 24.4 | 21.4 |
| MD stress @ break | | MPa | 57.6 | 51.7 | 52.1 | 60.5 |
| MD elongation @ | | % | 810 | 755 | 790 | 745 |
| break | | | | | | |
| TD stress @ yield | | MPa | 16.4 | 12.5 | 11.9 | 15.1 |
| TD elongation @ yield | | % | 10 | 17.8 | 18.9 | 14.9 |
| TD stress @ break | | MPa | 38.3 | 36.2 | 34.5 | 40.2 |
| TD elongation @ break | | % | 980 | 1085 | 1020 | 965 |
| ELMENDORF MD | | g | 137 | 142 | 545 | 268 |
| ELMENDORF TD | | g | 1710 | 1996 | 2091 | 1974 |
| THICKNESS | | micron | 73 | 69 | 73 | 79 |
| sealing strength | | N/15 mm | | | | |
| measured | | | | | | |
| at a Seal Temperature of (° C.) | | | | | | |
| | 110 | | 0.32 | 1.23 | 0.82 | 0.74 |
| | 115 | | 0.47 | 1.48 | 1.44 | 0.56 |
| | 120 | | 0.71 | 1.80 | 1.80 | 1.30 |
| | 123 | | | | | 2.20 |
| | 125 | | 0.87 | 3.40 | 3.10 | 2.80 |
| | 128 | | 1.40 | | | |
| | 130 | | 2.00 | 5.89 | 5.50 | 4.60 |
| | 135 | | 8.30 | 22.00 | 19.50 | 11.30 |
| | 140 | | 16.70 | 26.20 | 23.60 | 17.20 |
| | 145 | | 25.09 | 27.00 | 27.30 | 24.20 |
| | 150 | | 27.03 | 26.20 | 25.60 | 22.40 |
| | 155 | | 25.01 | 25.60 | 28.20 | 24.60 |
| | 160 | | 25.10 | | 22.90 | 26.60 |

TABLE 3
cast film samples from (HECO2) as base material component (a).

| Examples | setting | Units | Ref 2. | 4 | 5 | 6c |
|---|---|---|---|---|---|---|
| Component (b) | | type | | PB1 | PB3 | Affinity |
| | | | | | | 1850 |
| Amount of (b) in the composition | | wt % | | 20 | 20 | 20 |
| (a) + (b) | | | | | | |
| Clarity | | % | 68.6 | 59.4 | 70.5 | 68 |
| Film Thickness nominal | | mm | 0.07 | 0.07 | 0.07 | 0.07 |
| Haze on film | | % | 16.2 | 20.6 | 14.8 | 10.9 |
| GLOSS on film (45′) | | | 42.2 | 30.6 | 46 | 55.8 |
| Chill roll layer | | | | | | |
| GLOSS on film (45′) | | | 41.1 | 29.5 | 45.3 | 54.7 |
| external layer | | | | | | |
| MD stress @ yield | | MPa | 23 | 17.5 | 17.5 | 18.8 |
| MD elongation @ yield | | % | 15.1 | 20.7 | 25 | 17.6 |
| MD stress @ break | | MPa | 45.1 | 46.2 | 47.9 | 45.4 |
| MD elongation @ break | | % | 920 | 895 | 930 | 950 |
| TD stress @ yield | | MPa | 19.7 | 15.3 | 14.5 | 15.9 |
| TD elongation @ yield | | % | 13.3 | 19.8 | 18.6 | 9.7 |
| TD stress @ break | | MPa | 37.7 | 28.7 | 28.7 | 40.2 |
| TD elongation @ break | | % | 1040 | 740 | 750 | 830 |
| ELMENDORF MD | | g | 69 | 98 | 93 | 185 |
| ELMENDORF TD | | g | 170 | 556 | 1257 | 628 |
| THICKNESS | | micron | 70 | 71 | 70 | 69 |
| sealing strength | | N/15 mm | | | | |
| measured | | | | | | |
| at a Seal Temperature of (° C.) | | | | | | |
| | 110 | | 0.08 | 0.46 | 0.35 | 0.41 |
| | 115 | | 0.08 | 0.59 | 0.66 | 0.34 |
| | 120 | | 0.14 | 0.73 | 0.98 | 1.50 |
| | 125 | | 0.67 | 0.92 | 1.13 | 2.70 |
| | 126 | | | | 3.70 | |
| | 128 | | | | 6.00 | |
| | 130 | | 1.30 | 1.60 | 6.00 | 3.90 |
| | 133 | | 2.90 | | | |
| | 135 | | 6.00 | 7.80 | 11.10 | 7.60 |
| | 140 | | 17.90 | 21.40 | 21.30 | 7.10 |
| | 145 | | 23.90 | 26.90 | 24.00 | 8.60 |
| | 150 | | 27.30 | 27.40 | 23.50 | 10.80 |
| | 155 | | 24.20 | 27.00 | 23.80 | 17.60 |
| | 160 | | | 26.40 | 22.10 | 16.40 |
| | 165 | | | 27.70 | | 16.60 |
| | 170 | | | 17.50 | | 11.90 |

TABLE 4
blown film samples properties (HECO1 as base material)

| Examples | setting | Units | 7 | 8c |
|---|---|---|---|---|
| Component (b) | | type | PB1 | Affinity |
| | | | | 1880 |
| Amount of (b) in the composition | | wt % | 20 | 20 |
| (a) + (b) | | | | |
| Clarity | | % | 29.9 | 53.5 |
| Thickness nominal | | mm | 0.07 | 0.07 |
| haze | | % | 46.2 | 20.6 |
| GLOSS on film (45′) inside layer | | | 19.2 | 34.2 |
| GLOSS on film (45′) external | | | 18.1 | 36 |
| layer | | | | |
| MD stress @ yield | | MPa | 21.9 | 24.9 |
| MD elongation @ yield | | % | 19.6 | 23.7 |
| MD stress @ break | | MPa | 48.1 | 58.3 |
| MD elongation @ | | % | 990 | 1000 |
| break | | | | |
| TD stress @ yield | | MPa | 20.3 | 22 |
| TD elongation @ yield | | % | 18.9 | 16.2 |
| TD stress @ break | | MPa | 41.1 | 51.7 |
| TD elongation @ break | | % | 1050 | 1025 |
| ELMENDORF MD | | g | 67 | 180 |
| ELMENDORF TD | | g | 278 | 216 |
| THICKNESS | | micron | 66 | 69 |
| sealing strength | | | | |
| measured | | | | |
| at a Seal Temperature of (° C.) | | N/15 mm | | |
| | 110 | | 0.35 | 0.11 |
| | 115 | | 0.88 | 0.21 |
| | 120 | | 0.90 | 0.48 |
| | 121 | | 1.10 | |
| | 122 | | 1.54 | |
| | 123 | | | 0.85 |
| | 125 | | 2.20 | 2.10 |
| | 130 | | 3.98 | 3.10 |
| | 133 | | | |
| | 135 | | 13.50 | 7.30 |
| | 140 | | 22.30 | 18.70 |
| | 145 | | 23.30 | 21.50 |
| | 150 | | 22.40 | 21.70 |
| | 155 | | 23.50 | 22.30 |
| | 160 | | 23.00 | 22.30 |

TABLE 5
cast film samples properties before and after retorting (HECO1 as base material
component (a))

| Variable Name | setting | Units | Ref 1 | | 9 | | 10 | |
|---|---|---|---|---|---|---|---|---|
| Component (b) | | type | | | PB1 | | PB1 | |
| Amount of (b) in the | | wt % | | | 3 | | 5 | |
| composition (a) + (b) | | | | | | | | |
| Clarity | | % | 29.20 | | 18.30 | | 17.80 | |
| thickness | | mm | 0.08 | | 0.08 | | 0.08 | |
| HAZE on film | | % | 44.00 | | 55.30 | | 54.90 | |
| sealing strength | | N/15 mm | | After | | After | | After |
| measured | | | | retort at | | retort at | | retort at |
| at a Seal Temperature of | | | | 121° C. × | | 121° C. × | | 121° C. × |
| (° C.) | | | | 60′ | | 60′ | | 60′ |
| | 90 | | | | | 0.47 | | 0.74 |
| | 95 | | 0.04 | 0.26 | 0.16 | 0.70 | 0.13 | 0.60 |
| | 100 | | 0.18 | 0.38 | 0.24 | 0.66 | 0.15 | 0.62 |
| | 105 | | 0.24 | 0.36 | 0.30 | 0.61 | 0.34 | 0.46 |
| | 110 | | 0.42 | 0.79 | 0.38 | 0.55 | 0.49 | 0.89 |
| | 115 | | 0.36 | 0.85 | 0.89 | 0.62 | 0.82 | 0.82 |
| | 120 | | 0.69 | 0.85 | 0.89 | 1.00 | 1.11 | 0.86 |
| | 125 | | 1.40 | 0.96 | 1.60 | 1.20 | 1.20 | 1.20 |
| | 130 | | 2.20 | 2.00 | 3.08 | 2.20 | 2.90 | 2.10 |
| | 135 | | 7.60 | 5.40 | 10.80 | 7.40 | 25.30 | 7.10 |
| | 140 | | 20.10 | 18.00 | 25.80 | 22.20 | 31.10 | 23.50 |
| | 145 | | 28.40 | 25.40 | 30.90 | 28.80 | 31.00 | 29.20 |
| | 150 | | 30.00 | 28.60 | 32.30 | 29.90 | 33.60 | 31.70 |
| | 155 | | 28.80 | 29.30 | 29.40 | 29.70 | 30.50 | 30.80 |
| | 160 | | | 27.90 | | 33.20 | | 31.50 |
| | 170 | | | | | 28.50 | | 32.40 |
| | 180 | | | | | | | 31.20 |

| | | | | |
|---|---|---|---|---|
| Variable Name | setting | Units | 11 | 12 |

| Component (b) | | type | PB3 | | PB3 | |
|---|---|---|---|---|---|---|
| Amount of (b) in the | | wt % | 3 | | 5 | |
| composition (a) + (b) | | | | | | |
| Clarity | | % | 16.50 | | 18.20 | |
| thickness | | mm | 0.08 | | 0.08 | |
| HAZE on film | | % | 58.00 | | 53.70 | |
| sealing strength | | N/15 mm | | After | | After |
| measured | | | | retort at | | retort at |
| at a Seal Temperature of | | | | 121° C. × | | 121° C. × |
| (° C.) | | | | 60′ | | 60′ |
| | 90 | | | 0.44 | | 0.4 |
| | 95 | | | 0.42 | | 0.32 |
| | 100 | | | 0.38 | 0.07 | 0.41 |
| | 105 | | 0.17 | 0.55 | 0.29 | 0.61 |
| | 110 | | 0.32 | 0.59 | 0.32 | 0.48 |
| | 115 | | 0.56 | 0.46 | 0.60 | 0.66 |
| | 120 | | 0.82 | 0.92 | 0.60 | 0.87 |
| | 125 | | 1.40 | 1.07 | 1.40 | 1.25 |
| | 130 | | 3.00 | 2.10 | 3.20 | 2.00 |
| | 135 | | 10.90 | 7.90 | 15.70 | 7.40 |
| | 140 | | 23.80 | 20.40 | 21.30 | 21.60 |
| | 145 | | 28.20 | 30.30 | 30.90 | 28.20 |
| | 150 | | 29.10 | 30.30 | 28.90 | 29.40 |
| | 155 | | 32.30 | 30.40 | | 31.70 |
| | 160 | | 28.40 | 30.40 | | 29.40 |
| | 170 | | | | | |
| | 180 | | | | | |

cast film samples properties before and after retorting: base material
(HECO2)

| Examples | setting | Units | Ref 2 | | 15 | | 16 | |
|---|---|---|---|---|---|---|---|---|
| Component (b) | | type | | | PB1 | | PB1 | |
| Amount of (b) in the | | wt % | | | 3 | | 5 | |
| composition (a) + (b) | | | | | | | | |
| Clarity | | % | 66.30 | | 71.00 | | 68.00 | |
| Thickness | | mm | 0.08 | | 0.08 | | 0.08 | |
| HAZE on film | | % | 17.20 | | 16.80 | | 18.50 | |
| sealing strength | | N/15 mm | | After | | After | | After |
| measured | | | | retort at | | retort at | | retort at |
| at a Seal Temperature | | | | 121° C. × | | 121° C. × | | 121° C. × |
| of: (° C.) | | | | 60′ | | 60′ | | 60′ |
| | 90 | | | 0.10 | | 0.20 | | 0.1 |
| | 95 | | | 0.10 | | 0.52 | | 0.16 |
| | 100 | | | 0.20 | | 0.19 | | 0.16 |
| | 105 | | | 0.20 | | 0.27 | | 0.16 |
| | 110 | | | 0.20 | 0.06 | 0.16 | 0.06 | 0.16 |
| | 115 | | | 0.20 | 0.11 | 0.20 | 0.15 | 0.18 |
| | 120 | | 0.08 | 0.20 | 0.15 | 0.31 | 0.43 | 0.27 |
| | 125 | | 0.25 | 0.20 | 0.39 | 0.43 | 0.47 | 0.28 |
| | 130 | | 0.62 | 0.80 | 1.90 | 1.30 | 1.60 | 1.10 |
| | 135 | | 5.70 | 4.80 | 7.50 | 7.10 | 6.20 | 6.30 |
| | 140 | | 20.80 | 15.10 | 16.80 | 12.00 | 16.90 | 12.70 |
| | 145 | | 28.60 | 20.10 | 27.70 | 22.70 | 29.80 | 20.70 |
| | 150 | | 31.10 | 24.30 | 30.70 | 28.00 | 29.90 | 26.70 |
| | 155 | | 31.70 | 28.80 | 32.10 | 32.90 | 30.10 | 29.00 |
| | 160 | | 32.30 | 30.60 | 29.10 | 31.40 | | 31.60 |
| | 165 | | | 28.90 | | | | |
| | 170 | | 35.00 | | | 28.00 | | 30.60 |

| | | | | |
|---|---|---|---|---|
| Examples | setting | Units | 17 | 18 |

| Component (b) | | type | PB3 | | PB3 | |
|---|---|---|---|---|---|---|
| Amount of (b) in the | | wt % | 3 | | 5 | |
| composition (a) + (b) | | | | | | |
| Clarity | | % | 74.10 | | 67.80 | |
| Thickness | | mm | 0.08 | | 0.08 | |
| HAZE on film | | % | 14.50 | | 17.90 | |
| sealing strength | | N/15 mm | | After | | After |
| measured | | | | retort at | | retort at |
| at a Seal Temperature | | | | 121° C. × | | 121° C. × |
| of: (° C.) | | | | 60′ | | 60′ |
| | 90 | | | 0.16 | | 0.1 |
| | 95 | | | 0.18 | | 0.10 |
| | 100 | | | 0.17 | | 0.20 |
| | 105 | | | 0.13 | | 0.20 |
| | 110 | | 0.11 | 0.20 | 0.06 | 0.20 |
| | 115 | | 0.13 | 0.18 | 0.14 | 0.20 |
| | 120 | | 0.23 | 0.23 | 0.16 | 0.25 |
| | 125 | | 0.46 | 0.76 | 0.18 | 0.77 |
| | 130 | | 1.40 | 8.40 | 1.60 | 1.20 |
| | 135 | | 7.90 | 8.10 | 8.50 | 7.30 |
| | 140 | | 17.20 | 11.60 | 16.80 | 12.10 |
| | 145 | | 27.20 | 20.00 | 31.50 | 24.80 |
| | 150 | | 31.30 | 32.00 | 30.00 | 30.00 |
| | 155 | | 31.30 | 30.50 | | 30.00 |
| | 160 | | 27.00 | 29.90 | | 32.70 |
| | 165 | | | | | |
| | 170 | | | | | 27.60 |

1. A film or sheet comprising at least one layer of a polyolefin composition (I) comprising, in percent by weight referred to the sum of component (a1), (a2) and (b):
a1) 42-88 wt % of a propylene homopolymer or copolymer of propylene with ethylene and/or one or more C₄-C₁₀ α-olefin(s), the homopolymer or copolymer having a solubility in xylene at room temperature (XSm) of at most 10 wt %;
a2) 7-39 wt % of a copolymer of ethylene with propylene and/or one or more C₄-C₁₀ α-olefin(s) containing 50-80 wt % of ethylene derived units, and having a solubility in xylene at room temperature of 50-80 wt %; and
(b) 0.5-30 wt %, of a butene-1 (co)polymer having:
a content of butene-1 derived units of at least 75 wt %; and
a flexural modulus (MEF) of at most 70 MPa.

2. The film or sheet according to claim 1, wherein the polyolefin composition (I) has a Melt Flow Rate (230° C./2.16 kg) value of from 0.1 to 10 g/10 min.

3. The film or sheet according to claim 1, wherein component (b) is a butene-1 homopolymer or copolymer of butene-1 with at least another α-olefin having
a percentage of isotactic pentads (mmmm %) from 25 to 55%;
an intrinsic viscosity [η] measured in tetraline at 135° C. from 1 to 3 dL/g; and
a xylene insoluble fraction at 0° C. from 3 to 60 wt % of component (b).

4. The film or sheet according to claim 1, wherein component (b) is a butene-1/ethylene copolymer or a butene-1/ethylene/propylene terpolymer having the following properties:
a distribution of molecular weights (Mw/Mn) measured by GPC lower than 3; and
no melting point (TmII) measured via DSC.

5. A heat sealable film or sheet having a structure of A/B type or A/B/A type, where A is a layer made of or comprising the polyolefin composition (I) as defined in claim 1 and B is a support layer.

6. A polyolefin composition (I) comprising, in percent by weight referred to the sum of component (a1), (a2) and (b):
a1) 42-88 wt % of a propylene homopolymer or copolymer of propylene with ethylene and/or one or more C₄-C₁₀ α-olefin(s), the homopolymer or copolymer having a solubility in xylene at room temperature (XSm) of at most 10 wt %;
a2) 7-39 wt % of a copolymer of ethylene with propylene and/or one or more C₄-C₁₀ α-olefin(s) containing 50-80 wt % of ethylene derived units, and having a solubility in xylene at room temperature of 50-80 wt %; and
(b) 0.5-30 wt %, of a butene-1 (co)polymer having:
a content of butene-1 derived units of at least 75 wt %, and
a flexural modulus (MEF) of at least 70 MPa or less.

7. Manufactured articles comprising a film or sheet according to claim 1.

8. Flexible plastic packaging items comprising films or sheet materials according to claim 1.

9. Synthetic clothing articles, pipes, membranes or laminated articles comprising the films or sheet materials according to claim 1.
